(19) United States
(12) Patent Application Publication
(10) Pub. No.: US 2003/0171991 A1
(43) Pub. Date: Sep. 11, 2003

(54) Apparatus and method for advertising in a multimedia environment

(76) Inventor: Michael Scott Robbins, San Diego, CA (US)

Correspondence Address: MICHAEL SCOTT ROBBINS, 18102 FRESHWATER CR., HUNTINGTON BEACH, CA, 92648, US

(21) Appl. No.: 10/348,092

(22) Filed: Jan. 21, 2003

Related U.S. Application Data
(60) Provisional application No. 60/349,503, filed on Jan. 22, 2002.

(51) Int. Cl. G06F 17/60

(52) U.S. Cl. 705/14

(57) ABSTRACT

The present invention is a method and apparatus to insert unavoidable audiovisual advertisements for content providers such as radio station streamcasters. When a person clicks on content provider's website to receive free content, the user must first pass through an audiovisual advertisement. If the user attempts to evade the commercial by minimizing the browser or alt-tab, then the advertisement stops and the user returns to the previous page. Subsequent advertisements require the user to watch the entire commercial before continuing with requested content. Once the commercial(s) finish, the user can access content requested and minimize the browser or alt-tab without interrupting content request. By requiring users pass through a gateway commercial, and making the terms of watching the commercial more strict, the present invention creates high value, homogeneous advertising units.

### CROSS-REFERENCE TO RELATED APPLICATIONS

References Cited:

U.S. PATENT DOCUMENTS

U.S. Pat. No. 6,285,987 September 2001 Roth et al.

U.S. Pat. No. 5,740,549 June 1995 Reilly et al.

U.S. Pat. No. 5,515,098 May 1995 Carles et al.

U.S. Pat. No. 6,314,451 November 2001Landsmen et al.

U.S. Pat. No. 6,161,127 December 2000 Cezar et al.

U.S. Pat. No. 5,781,894 July 1998 Petrecca et al.

U.S. Pat. No. 6,026,368 February 2000 Brown et al.

U.S. Pat. No. 6,324,566 November 2001 Himmel et al.

U.S. Pat. No. 5,933,811 August 1999 Angles et al.

U.S. Pat. No. 6,009,409 December 1999 Adler et al

U.S. Pat. No. 6,009,429 December 1999 Greer et al.

U.S. Pat. No. 6,119,098 September 2000 Guyot et al

U.S. Pat. No. 5,948,061 September 1999 Merriman et al.

U.S. Pat. No. 6,128,651 October 2000 Cezar

U.S. Pat. No. 5,572,643 November 1996 Judson

U.S. Pat. No. 5,999,912 December 1999 Woodarz et al.

U.S. Pat. No. 5,903,727 May 1999 Nielsen

U.S. Pat. No. 6,481,012 November 2002 Gordon

U.S. Pat. No. 6,317,761 November 2001 Landsmen et al.

U.S. Pat. No. 6,141,001 October 2000Baleh et al.

U.S. Pat. No. 6,064,379 May 2000 DeMoney

U.S. Pat. No. 5,861,880 January 1999 Shimizu et al.

U.S. Pat. No. 5,515,490 May 1996 Buchanean et al.

U.S. Pat. No. 6,167,432 December 2000 Jiang

U.S. Pat. No. 6,078,942 June 2000 Eisler, et al.

### STATEMENT REGARDING FEDERALLY SPONSORED RESEARCH OR DEVELOPMENT

Not applicable

### BACKGROUND OF THE INVENTION

1. Field of Invention

Definitions

Users—End-users who request Internet content

System Software—The name referring to all or a part of the enabling present invention. The System Software may be located on servers, encoders and local machines.

System Provider—The name of the authorized company giving access to System Software

The inventor has created a method to overcome internet users' propensity to ignore advertisements. The preferred embodiment is a full screen with audio commercial. Twenty-nine and a half million Americans used Internet audio or video in January 2001. According to Arbitron, this was 13 percent of the U.S. population, up from 10 percent January 2000. A July 2001 Arbitron study reported that 52% of Americans online had used streaming media. This data demonstrates there is a growing number of internet users with speakers and the ability to receive audio as well as visual content from their computers.

To date, economic volatility has not kept more people from going online for the first time everyday. Growth is slowing, but the number of internet users globally continues to rise. More people are also streaming for the first time. Streaming is one of two general ways to experience video or sound from the internet, the other being downloading files.

Many webcasters have ceased streaming because of low advertising revenue from banner or audio-only formats. These formats run a low risk of annoying users, however they are consequently ignored and bring little value to the advertiser. Music royalties and bandwidth costs can quickly increase the cost of maintaining a website. The need for a significantly better business model is a hot topic in trade magazines.

The inventor, hereafter referred to as the System Provider, has invented a method and apparatus that forces users or “streamies,” people listening to streaming media, to pass through a full screen ad with audio before receiving requested content, similar to a movie trailer. Currently when Internet users want to listen to online radio, sports or news, they may see a banner ad or hear an audio-only ad, but they are never required to sit through a full screen ad with audio before getting their content. The present invention that facilitates this, hereafter referred to as System Software, does not allow users to receive content if they minimize the web page in the browser or escape the visuals with alt-tab. One embodiment is a flash advertisement in a frameless window that cannot be moved by the user. If a user attempts to evade the commercial, the commercial will stop, and the user will not be given access to content requested.

To increase the value and revenue generated from online advertising, many companies have sought to add in-depth profiling. However, if the advertisement is a pop-up and closed by the user before the graphic is loaded, the internet user is not exposed to the advertiser's message and the depth of profiling is irrelevant. One embodiment of the present invention utilizes multiple profiling and billing scenarios. The few companies that use full screen interstitials rarely complement the advertisement with audio. The present invention forces every profiled user to watch a commercial before receiving content. In this embodiment, the System Provider can assure to a greater degree that every user saw and heard the advert in its entirety. The present invention overcomes users' natural tendency to ignore advertising. The preferred embodiment has requested content stored at a dynamic URL so the user cannot bookmark it or resell.

Cost-Per-Thousand, known as “CPM” in the advertising world, is how media are judged for the value of exposure provided. Many factors determine CPM such as demonstrated impact of a particular ad format. Sometimes advertisers are billed on “clicks.” The decline in click-through-rates (CTR) of banner ads has been from 3% in 1996 to 0.4% in 2002. Pop-ups had a CTR of 7% in 1996, but dropped to 3% and lower by 2002. CPMs of banner and pop-up ads have fallen proportionally as the formats lose novelty and the ability to be noticed. Schoskles, which are DHTML ads embedded in a web page, have had a CTR of 25%. A schoskles ad usually runs five seconds and can be ignored by minimizing the browser or switching to another browser on a different web site until the schoskles is done. The present invention functions as a gateway, rather than temporary obscuring content. The long-run CPM expected from present invention is expected to be significantly higher than banner ads.

Distributors of content such as online radio have been in decline, but usage is up. Some publishers and broadcasters have abandoned advertising altogether, and only offer a micropayment subscription model for users to access content. Previously, content providers found that they were not getting a return on investment. Whether costs include content acquisition, bandwidth or introduced music royalty fees, content providers struggled to provide advertisers sufficient value. Often most of the people listening to a radio station online are not in the vicinity of the free-to-air transmission. Consequently most listeners are not relevant to local advertisers and don't add value when a free-to-air radio station streams online. The present invention's ad insertion syndication strategy uses geographic profiling so U.S. advertisers can target U.S. listeners, regardless of where the broadcast originates. Some companies in online radio ad insertion have learned that a cooperative model is the best way to deal with such a dispersed audience, but they have been afraid to annoy users with more intrusive formats. If less intrusive formats such as banner ads were worth enough to pay costs, or if users had no reservations about making micropayments with a credit card, the present invention would be less intriguing.

Another cost making streaming cost prohibitive is driven by AFTRA (American Federation of Television and Radio Artists). The U.S. rule is causing some radio stations to stop streaming, especially smaller stations. The AFTRA regulation requires stations to pay celebrities (who read free-to-air ads) a 300% bonus when the audio advertisement is streamcast over the web, even if online listeners are geographically irrelevant to the advertiser. According to CNET.com Jun. 18, 2001, Mathis Dunn, Assistant National Executive Director of Commercials for AFTRA, said paying union talent 300 percent of a normal fee would amount to about $660 for an ad that could be used on the Internet for a maximum of 21 months.

The turmoil in the online radio business has caused many stations to reluctantly cease webcasting, but more people are still tuning into webcasts everyday. The present invention gives access to content to people who do not have, or do not wish to use, a credit card or e-wallet.

The System Software pre-caches a multimedia advertisement, which stays synchronized with the audio. Caching is a methodology that can be used to pre-load content on a user's computer. Caching is most important when the user's bandwidth is limited. Without pre-caching, the loading of visual elements competes with the audio portion of the stream for bandwidth. If pre-caching were not employed, even with broadband there can be audio talking about a graphic that is still loading and only partially displayed.

The System Software requires no download for end users. Standard browsers such as Internet Explorer or Netscape in combination with Windows Media Player, QuickTime or RealPlayer are sufficient to transverse the advertisement, which may occur as an initial gateway to content or reinserted at intervals.

In one embodiment, the System Software usess IP address resolution so thatusers are instantly geographically profiled, and a ZIP code question follows for some national users. After searching for counties of users and analyzing those channels of interest, the advertiser or facilitator selects channels and allocates funds for users with IP addresses from designated countries.

When a user clicks on a content's web site to receive premium content, the System Software advises the user on implications of interrupting the advertisement. If the user is in the same country as a free-to-air radio station, the user may be asked for a ZIP or postcode. A hyperlink in one embodiment explains the need and functionality of the present invention in more detail. System Provider may force any user to pass through a questionnaire.

The warning message hangs printed in the language of the user by corresponding country to language. A help button allows users to accept a cookie for changing default language-country correlation. This helps dictate if the following advertisement should be in English even though the user is in Thailand. To proceed to the gateway advertisement, the user must click again, acknowledging the rules of watching the commercial.

If the user elects to watch the commercial, the advertisement begins and may be followed immediately by more advertisements subject to the same rules. Minimizing the screen or alt-tab prior to the ad completing prevent the user from getting the content requested. After the commercial(s), the user may minimize or alt-tab without triggering an event by the System Software, until more commercials are inserted.

A web interface permits advertisers and content providers to delegate and approve gateway ads. Advertisers search through the demographics of System Software users and evaluate content providers with those users. The present invention contains a method for advertisers to select an appropriate content provider by searching a database with user demographics and content descriptions. Depending on the demographic data of the user, different advertisements may be shown. The advertiser allocates funds to certain users of certain content providers. Content providers are notified of new ad funds committed and logon to approve the ads. System Provider facilitators help advertisers assemble commercials and plan media buys on the network. The present invention captures statistics about how many users turn away and those who go through to the advertiser's web site and make a purchase.

The preferred embodiment of the present invention is in two parts, residing on the audio encoder and on a System Provider server(s). Whether or not there is live broadcasting and a need for the System Software to reside on an audio encoder, a signal is received by the System Software indicating when a user has blurred the screen or changed focus. Various levels of user interaction are tracked such as clicking on the window, clicking on a link or making a purchase.

2. Description of Prior Art

“Starship Troopers” Columbia TriStar (1997). News media system ‘would you like to know more?’

“BigFatRadio” Sydney, Australia (2000)

“FireTalk/PalTalk” Web tours

“HiWire” Audio banner ads

“Microsoft” Full screen interstitials

“Clear Channel” Video gateways

None of the examples of prior art provide an advertisement format that prohibits avoidance from alt-tab or minimize.

### SUMMARY

Most advertising on the web allows the trained user to unconsciously ignore ads and pursue the content: closing Pop-Ups before loaded; scrolling down before a banner shows its graphic; scrolling past even large ads embedded in articles, users barely register the advertising ‘event.’ A lot of shareware is available to block ads. With Tivo™, one can simply fast-forward. The lack of some ad formats' intrusiveness is directly tied to the low value of the format. When it comes to online radio, advertising revenue requirements can be very high. The System Software ads are particularly effective because users cannot elect to interrupt a commercial and still receive or continue to receive desired content. Cash-strapped internet content providers are willing to lose the impatient portion of their audience in order to turn a burden into a profit center. The present invention strives to provide the most effective advertising concept available.

### ADVANTAGES

The audio banner ad is commonly used by webcasters, and does not command undivided attention. While the audio component cannot be skipped, audio alone is greatly inferior to audiovisual commercials like on television. The present invention does not allow commercials to be fast-forwarded, such as when watching Tivo™ or an on-demand video stream in a normal media player. Unlike television, the present invention does not allow the user to change the channel during a commercial.

Obtaining a relatively high level of confidence in the impact delivered by each commercial in the present invention provides a standard. Otherwise, the value of the commercial may be diminished when the user minimizes the graphics halfway through the corresponding audio. The present invention allows the System Provider to market homogeneous advertising units without the need to discount the price of any impression because the user turned off the commercial's ability to express a message visually.

Unlike the pop-up, the preferred embodiment of the present invention utilizes a warning screen, giving the user the options to pay a subscription fee or drop their content request before the advertisement is initiated. Existing pop-up ads do not politely introducing themselves. When several appear spontaneously, users will tend to become annoyed, while the present invention is not annoying for being unexpected, but only restrictive.

### BRIEF DESCRIPTION OF DRAWINGS

FIG. 01a: Option to subscribe or watch ad. Direct toward advertisement or question page.

FIG. 01b: Illustrates effect of content provider using postcode question and creating blocks

FIG. 01c: Illustrates effect of absent embedded advertising and two payment models

FIG. 02a: Illustrates login by System Provider, Auditor, Content Provider (Streamcaster), and Advertiser

FIG. 02b: Illustrates System Provider admin

FIG. 02c: Illustrates Advertiser admin

FIG. 02d: Illustrates Streamcaster admin

FIG. 02e: Illustrates Advertiser creation, demographic search and allocation

FIG. 02f: Illustrates live URL insertion

FIG. 03a: Illustrates user experience and claims

### DETAILED DESCRIPTION OF THE INVENTION

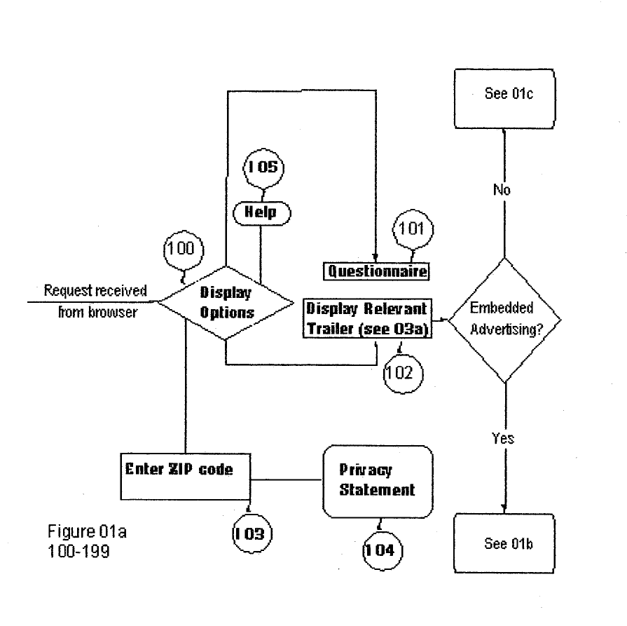

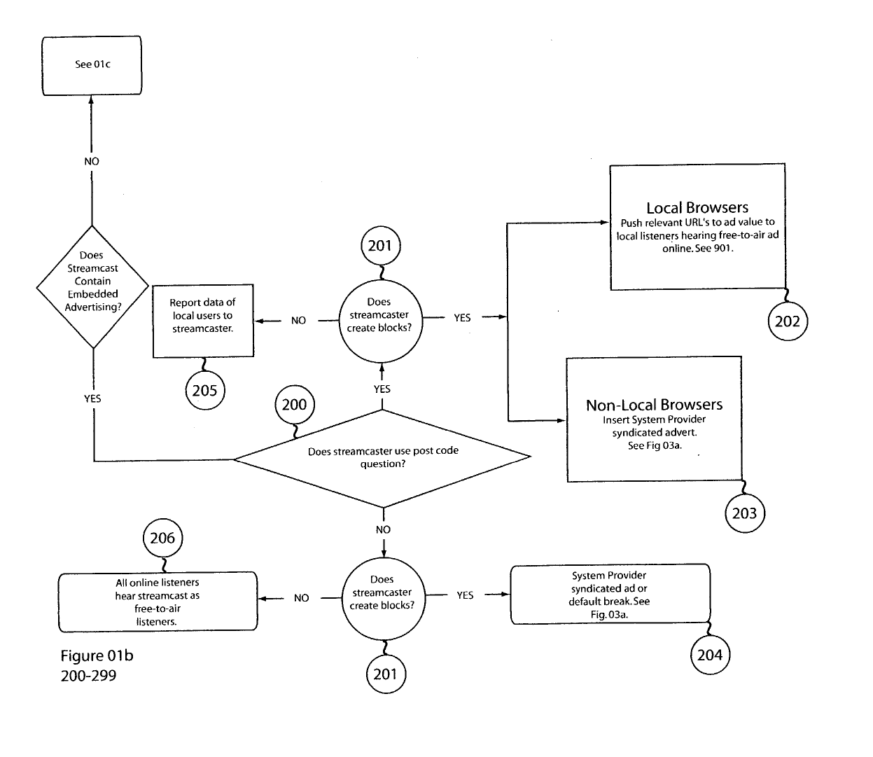

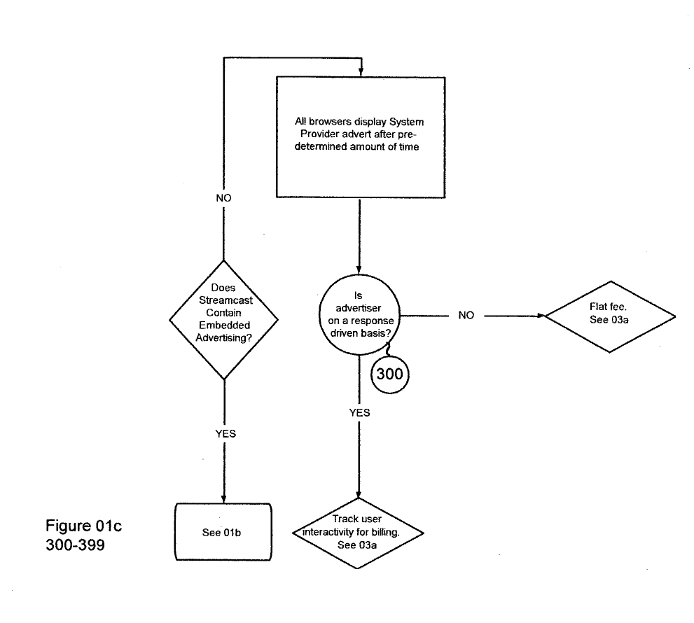

User Differentiation FIG. 01a

These are the steps that most end users experience. The first step 100 displays options and instructions. In step 100, IP address resolution checks to see if user is in a country that requires entry of postcode 103. If the user desires, advertisements can be avoided by filling out the subscription questionnaire 101. Subscribers are directed toward requested content outside the scope of the present invention. Users not diverted to 101 proceed to Step 102. Post Code question can be supplemented or replaced (as dictated by System Provider on a per streamcaster basis), with additional questions (backed with cookies). A privacy statement discloses process 104. Users in countries with no paid ads to display are referred to System Provider set default, which is a charity advertisement or a stop page prohibiting nonsubscribing users from receiving content. Users with WP masked or cookies off directed to “Help” 105 for computer check-up.

When a user clicks on the screen during an advertisement, there may be no effect or a freeze on any new visuals pushed until user clicks a “return to current page” button that flashes when visual, graphic or URL stream is frozen. If there is a freeze on new visuals pushed, the user is free to navigate the advertiser's web page. The audio continues regardless if user visits other links. Some framed pages (without pre-processing) may cause the streamcast to terminate if a user clicks on a link. One embodiment provides a note suggesting users “Open in New Window,” or automatically make any link clicked open a new window.

A Help Button 105 marked with “?” goes to a webpage with the following navigation: Are You System Software Ready, Links, Advertisers, Investors and Partners, Register, Notification of Subscription Model and Questionnaire, Privacy Statement, User Advocate and Language Default Override.

Embedded Advertising—Ad Replacement & Blocks FIG. 01b

Some radio station streamcasters need to replace ads or create scheduled breaks or Blocks 201. When a free-to-air audio ad is streamcast online, the number of listeners is reported, especially local listeners 205, to account for bonus to talent unions. Most will probably create blocks to account for online listeners in free-to-air region 202 and pay union fees. A block that keeps the free-to-air ad playing for the local audience consequently allows for more System Software syndicated ads for listeners not in the country or ZIP code area 203. However, some will create blocks to ensure no online listener hears the same ads heard by the free-to-air audience 204. Creators of blocks may or may not use the ZIP question. No postcode question or use of blocks brings all users to 206.

The postcode question model 200 is activated by System Provider per streamcaster 503. Then streamcaster can enter user's country that causes Post Code question, allows report summaries to be viewed (number of users per post code range, maximize and other levels of interaction during ads) and allows the creation of blocks.

Some postcodes entered by users may not be desired range of streamcaster, even though users are in the same country. Those users with out-of-range postcodes may be directed toward syndicated country ad or a Gender, Age, etc. question 101, as dictated by System Provider.

Interactive Rates on Syndicated Advertisements FIG. 01c

In order to permit billing based on user interactivity 300, formally known as “click-through,” the System Provider must beta test each advertiser to ensure metrics continue to provide profitability. Those advertisers charged based on interactivity in one embodiment begin after the gateway during scheduled breaks called Blocks. It is possible, however to permit response driven gateway commercials. The preferred embodiment does not relax gateway advertisement restrictions, which prohibit negative responses such as alt-tab and minimizing.

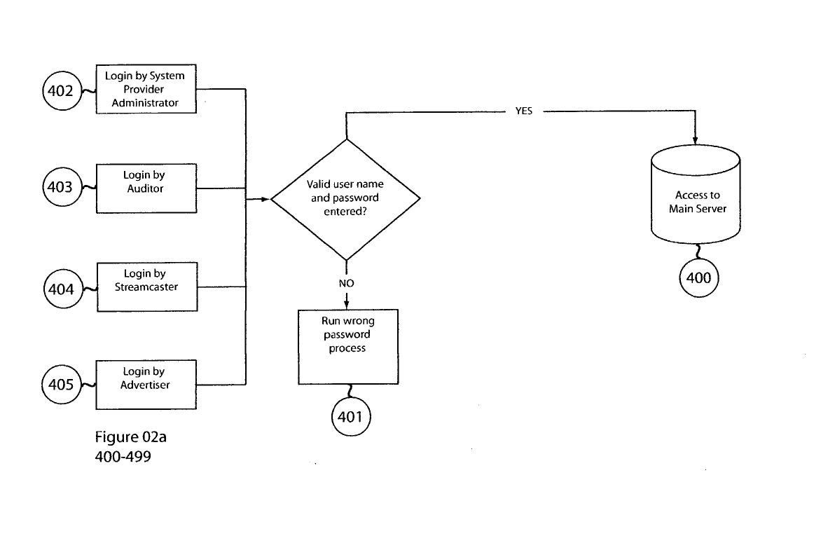

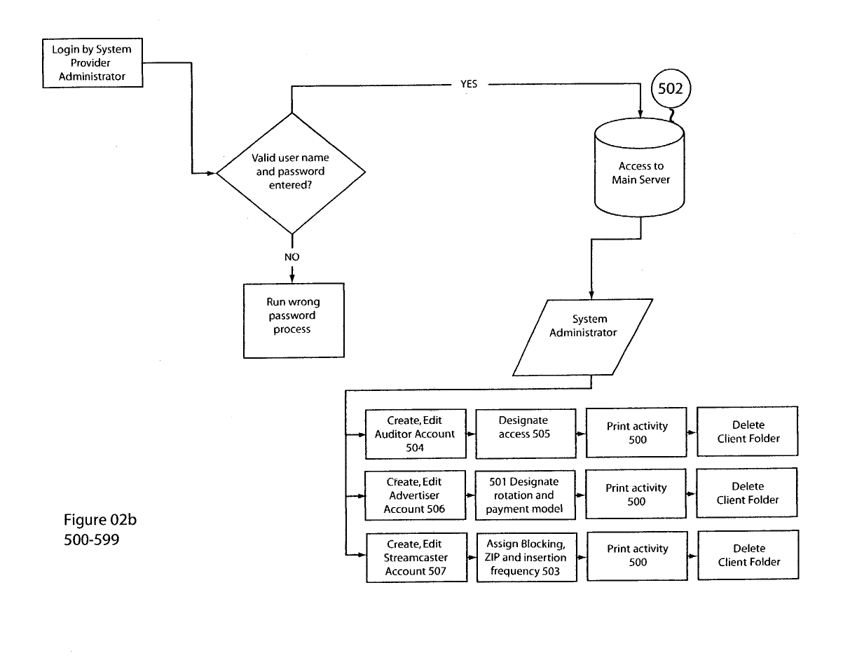

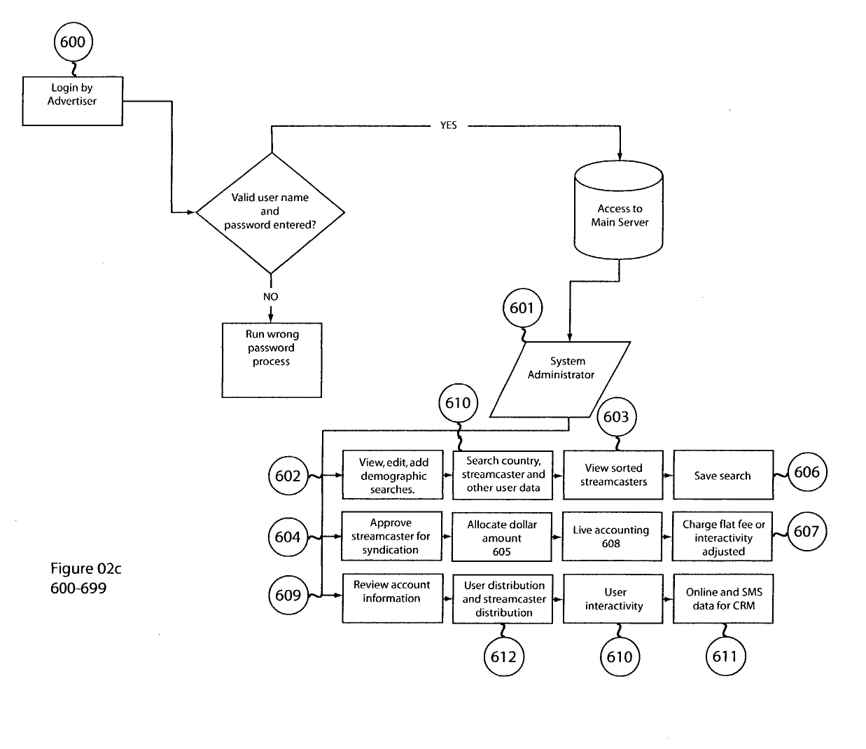

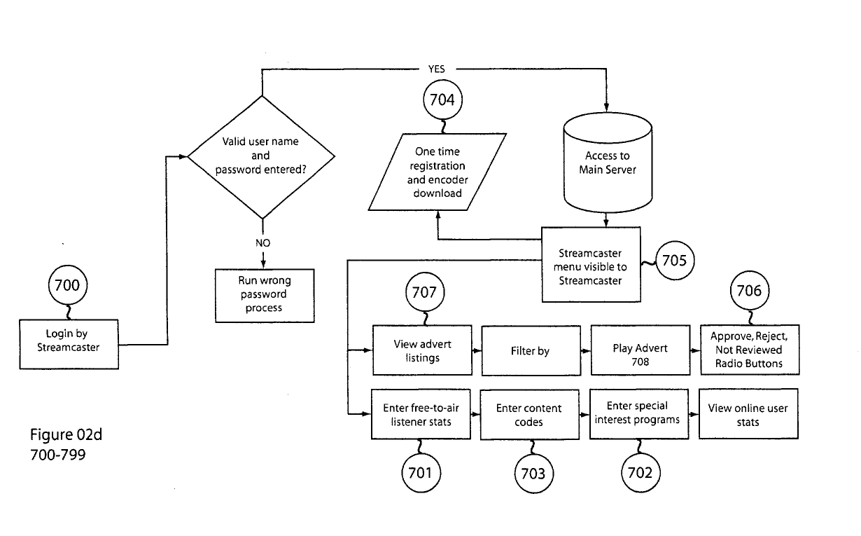

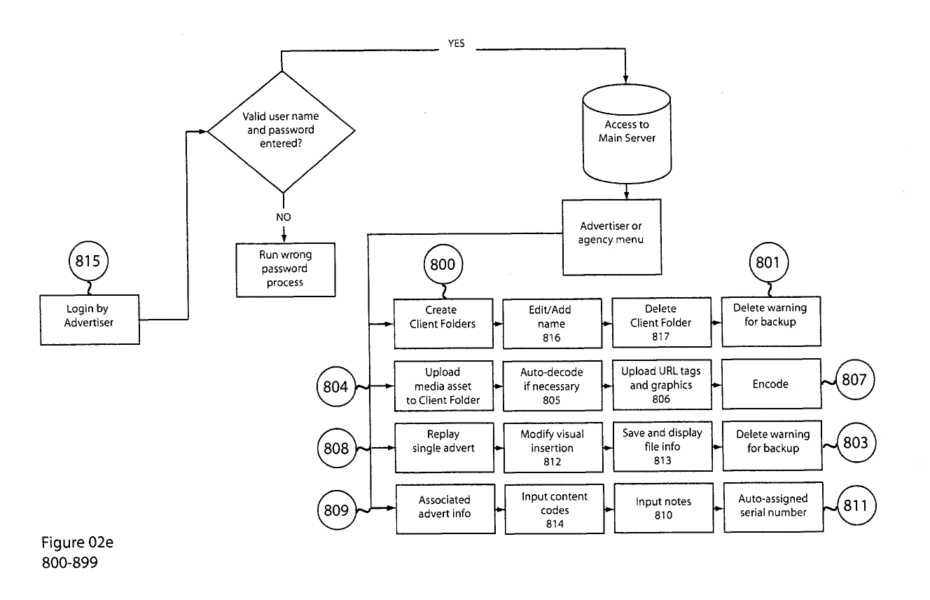

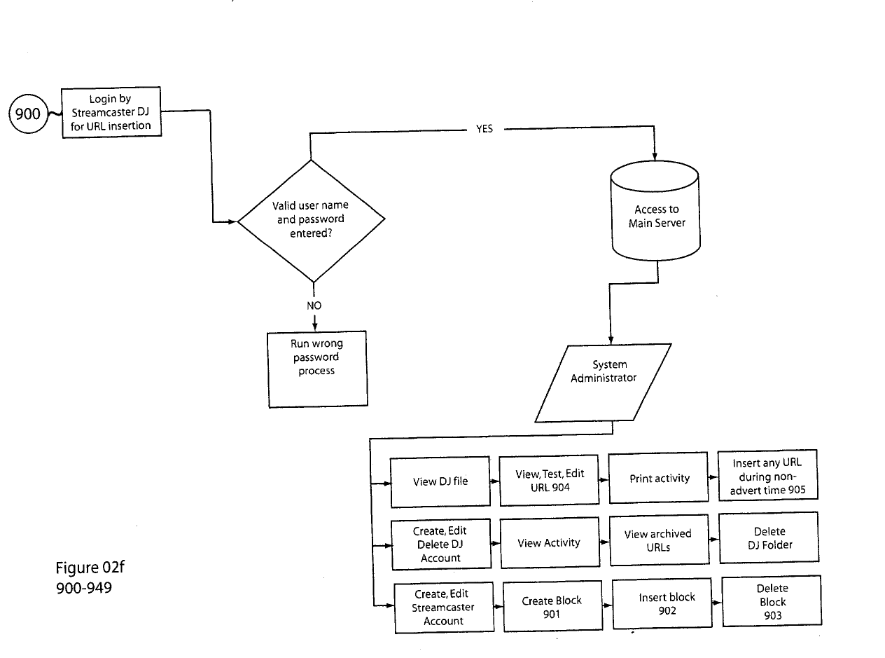

Ad Server Security FIG. 02a

A central but scalable admin/advert server 400 is necessary to create, edit, store, delegate, approve and monitor ads. Security user/password access is provided for System Provider 402, auditors 403, and Streamcasters 404 and advertisers 405. Streamcasters may only view adverts allocated to them for approval. Auditors have access required, designated by Service Provider 505. Wrong Password Process 401 contains: Alert user by e-mail, three second delay, warning of two more attempts, permit re-login.

System Provider Admin FIG. 02b

If a streamcaster creates blocks 503, the System Provider can may choose to keep automatic reinsertion frequency at ‘never’ and operate profitably. Rotation 501 is determined by System Provider, which views all data per streamcaster and selects from list of rotation patterns. Pre-Paid, flat cost-per-view-per-second (CPVPS) is default rotation to the least recently displayed ad accepted for approval. Other rotation pattern options include:

1) Placement by highest CPVPS rate (may allow for an embodiment of bidding for rate). When equal, the default goes to highest allocation available. For Response Driven payment plans (Variable CPVPS) an implied CPVPS is used.

2) Placement by order in which approved by streamcaster.

3) Custom order until allocation consumed.

An auto-update of placement rate and estimated time to consumption of allocation is viewable to advertisers 609. One embodiment notifies advertiser when expected consumption date changes by more than 1 week.

The System Provider logs onto Streaming Server 502, which contains other half of System Software. The streaming server accepts streams from designated regional System Software encoders 507.

Auditor accounts 504 are created and associated with streamcasters or advertisers by System Provider Administrator 505. An advertiser account is created 506, and the present invention tracks and reports usage to System Provider admin and accounting 500.

A special interface of the present invention allows for tracking songs per user compatible with streamcaster's software for song data. Remote diagnostics and upgrade apply to encoder 704 and server software 502. The System Provider can see/print/export 500 in .csv format all information for forecasting: monthly advertising placed and amount of allocated funds unused per advertiser, monthly revenue per station and net profit from each station from established incoming and outgoing bandwidth costs from network provider, and showing subtraction from revenue of ads placed. System Provider authorizes interactivity-based payment plan per client folder 501.

Advertiser Selecting Demographic and Funds Allocation 02c

The advertiser logs in 600 and sees the Advertiser Interface 601. Media assets reside in a depository. Placements are authorized by saving different searches 602 associated with a media asset that has funds allocated.

The advertiser may begin by screening all System Software servers by country of user. Multiple simultaneous countries may be selected in a single search. Advertiser must select one or more counties. A separate search may be done with AND/OR Boolean or dropdown fields of name of streamcaster, parent company, call sign. The advertiser reviews statistics of streamcasters for percentage of users per country and raw number. Streamcasters are ranked by raw number of target users with the most relevant at top 603. Other information reported includes: unique users last month, peak concurrent users, average concurrent users, average listening time.

Another embodiment provides a screen for all System Software servers' User Stats. This applies an increase CPVPS (Cost Per View Per Second) per additional criteria screened such as: postcode, gender, age, income, or other parameters created by System Provider. This data may be collected by the same method as postcodes, before the ad. The search is saved 606 against media asset, and can be saved without a fund allocation. same method as postcodes, before the ad. The search is saved 606 against media asset, and can be saved without a fund allocation.

Advertisers select which content providers using the System Software may run ads 604 for specified user demographic, confirm/edit demographic search criteria and enter dollar amount allocated 605. The streamcaster is notified immediately and asked to approve commercial. Once the streamcaster approves 706, the advert enters the rotation queue for placement. Accounting is live for System Provider and Advertiser.

A single dollar allocation is associated with each commercial 605, however different searches 610 can be associated with same advert and allocation. An allocation can only be made by the authorized advertiser. Live accounting 608 is available for advertiser of placement, and information is automatically added to streamcaster admin for approval. Saved searches are shown under each advert. “View All” 609 means they see all adverts created with saved searches. Also show: ID number, ad name, duration, credit available, initial placement date, streamcasters approved, placement rate per streamcaster, estimated date of completion, CPVPS (Cost per view per second) and notes. This has a filter facility based on multi-criteria to view certain screens.

Advertisers can be charged based on two different rates, which may also be combined 607. Default is fixed rate.

The fixed rate uses a base CPVPS (Cost per view per second) rate per advertiser client. The base CPVPS is visible in advertiser's administration page. One embodiment includes rate adjustment by profiling: ZIP, special interest, user registration, data from streamcasters.

The response driven billing method is also reported 610, but fixed rate clients may be charged for access to this information. User response adjusters are tracked for billing and statistics are displayed in Advertiser's admin. User interaction is visible to Basic Streamcaster 900 login and Advertisers 600. The following are six levels of possible user interactivity:

User maximizes window±χ CPVPS

User clicks on window, freezing URL stream±χ CPVPS

User clicks on link to surf advertiser's site±χ CPVPS

User makes purchase on e-commerce site (single pixel tracking or cookies)±χ CPVPS

User elects to repeat ad at next insertion±χ CPVPS

Show to friend±χ CPVPS

User data viewable includes: who pushed the ad and how often, how many users watched all or a part of the commercial, top IP addresses seeing the ad repeatedly, in what countries are the ads being seen 612. All response measures, online and wireless survey data can be viewed 611.

Streamcaster Registration FIG. 02d

Streamcasters have a login page and passwords for two levels of access. Full streamcaster security access 700 includes the above and access to System Software advert approval. Basic 900 includes Ad Replacement (blocks), User Statistics (no CPVPS or billing info) and Live URL insertion. Registration Information 704 for encoder software download through online interface and input the following data (*Mandatory): *Brand name of Streamcaster, Call number, *Parent name, *URL, live, on demand (streaming), download plus other Contact information. Free-to-Air Statistics* 701 Average age, Audience gender make up %, Age range, Average income, Income range Interests of Streamcaster 702 are also inputted.

Politics questionnaire 703 for radio stations in admin page, which sends email to facilitator of the policy change, not just that one occurred: Has ads for abortion clinics in past 6 months, Will not have ads for abortion clinics, Adult, Tobacco, Guns, Alcohol/Cigarettes, Contraception, Cannot accept ads from [List all other interest categories (i. - nᵢ)]. Other information reported includes music genres, political interest or government owned, and religious-based. Entry information automatically dated (in streamcaster's timezone) whenever changed. Timestamp is also visible to advertisers. An optional digital signature of auditor with date substantiates this.

One embodiment creates timezones of interest so if an IT show is on a radio station every Monday 6PM-8PM, an advertiser searching Interest groups may designate certain programs to sponsor.

A full Security Access Streamcaster sees available advertisements 707 with content codes. Radio buttons distinguish approval status: Approved, Rejected, Not Reviewed 706. Approved initiates placement and send confirmation email to advertiser. The timestamp is saved on the web for placement rate calculation. Rejected provides streamcaster an option to explain why it rejected, and sends email to advertiser. A link 708 allows the streamcaster to play media asset commercial.

Create advertisement media asset FIG. 02e

The creation of a commercial is an ability of advertisers or the System Provider's designated facilitator 815. A single advertising agency may have different account executives with different login/passwords, which lead to different groups of client folders 800. In each advertisers login page, the advertiser may edit clients 816. They can also be deleted 817, which carries warning of deleting uploaded media assets within client folders 801. If an advertiser selects delete, an option suggests Advertiser saves media asset event in commonly used video screen shot format with links to top providers of the software, or option to hide it on the list of available media assets rather than physically deleting it 803. System Provider admin sees advertiser's hidden assets and the date they became hidden.

The creation of the complete advertisement ready for the System Software in one embodiment is significantly automated. First, the advertiser selects the client folder to upload media asset into 804. Software assists in the following: uploading audio file in any format to ad server, auto-decoding on ad server if necessary 805, uploading graphics and URLs 806. Step 806 may alternatively be flash animation. With audio and visual content prepared on the ad server, the file can be encoded 807 with synchronized visuals and played back 808.

Two known options for inserting visuals 812: one is to insert graphics and/or URLs by live streaming, or inserting time of desired display within accompanying audio file. Inserting based on time assumes the advertiser has listened to the audio and knows the length and second to display each visual.

The media asset needs to be automatically timed, and the length recorded in the summary 809. Auto-encode 807 allows the advertiser to click a button and initiate a remote encoding process. Advertisers enter any notes in field 810. The notes field created/edited by the advertiser is visible to approved streamcasters. Content Codes are also entered 814 with optional auditor verification. One embodiment contains an auto-assigned serial number 811, and display of creation, modify and size data 813. In the replay of the encoded file 808, all visuals cached before replay begins. Options include: Save, Delete, Replay, Edit, modify visual insertion±seconds or restream live 812. The process encodes over the old file and is stored 813.

Blocks and Live URL insertion FIG. 02f (900)

One embodiment for the creation of “Blocks” can be illustrated in the following manner. The streamcaster engineer or DJ 900 prepares a file 901 that contains the following information: Local Advertiser, URL(s), user interaction reporting, name, length, auto-assigned ID, time/date scheduled (automatically cached but not inserted).

The streamcaster has the option to rename, edit and delete components and the filename. The DJ then simply looks at the list of blocks chronologically, and selects the relevant one 902. As soon as he selects the block, the URL(s) get pushed for the length of time specified. Local online listeners hear the radio advert and see the URL. If a specific advertiser does not have a URL, then streamcaster home URL displays. The length of time allocated for this process is sent to the Ad Server that plays adverts to other listeners for the same aggregate length of time. If global adverts available don't fill up block time, then the ad server plays generic filler so that there is no long pause.

Streamcasters may review reporting about local listener activity during the commercials. If advertisers agree to a single pixel gif file being inserted on key pages, the present invention can track e-commerce through their site. Block can be deleted 903.

If a Streamcaster is not generating enough revenue, the System Provider may require online listeners to see another syndicated ad 503 every 15, 30, 60, 90 or 120 minutes. One embodiment permits the streamcaster to decide whether advertisements force visuals after the gateway.

Live URL insertion by basic security level access Streamcaster 900 allows DJs to have the ability to enter URLs of their choice that are displayed to all listeners during no advert time 905. One embodiment allows URL insertion on the fly, caching, streamcaster activated and panic button. DJs must have computer screen and choose URLs at least one minute in advance to be pre-cached, however they may insert any URL on a non-cached, ASAP basis. URL test 904 is used to ensure pushing the web page won't cause audience to lose stream.

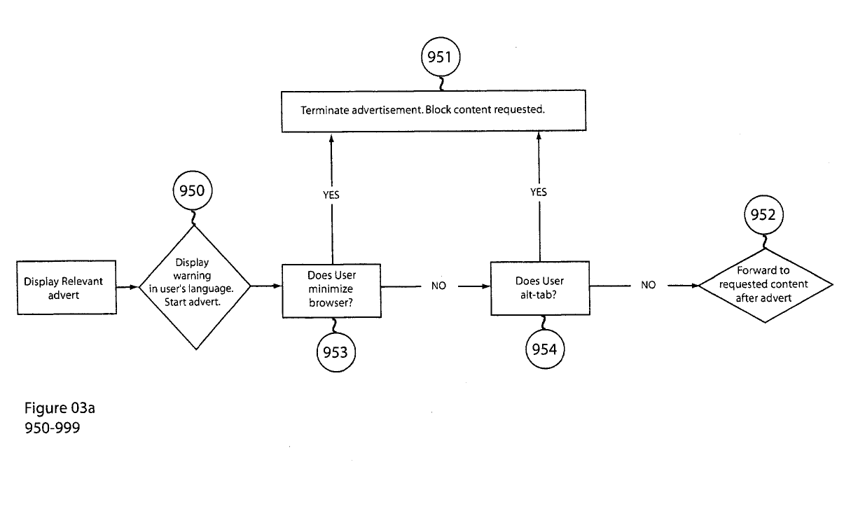

User Experience FIG. 03a (950)

The inventor's claims are best illustrated in this figure of the preferred embodiment. Step 950 a visual warning displays to the effect “To receive content requested you must first pass through an advertisement without avoiding it. Minimizing the screen or alt-tab will terminate the commercial and prohibit you from receiving content requested. Alternatively, you may subscribe to eliminate these commercials. Click ‘Help’ for more information.” The warning is displayed in the expected language of user, determined by preferences, country-language correlation or cookie override. This verbiage hangs silently for about seven seconds or until following commercial is completely cached. The user may or may not be required to click again, initiating the ad. The appropriately syndicated advert begins. In some embodiments a button X is embedded in the player to represent the merger of close and minimize functions, or the standard window buttons are used with a log-event to activate termination. Alt-tab is detected through log event. Detection of alt-tab and other keystokes that could allow ad evasion can be detected as “change of focus” or in Java as “blurring.” Clicking this button 953 or alt-tab 954 terminates the stream 951. Dynamic URLs for advertment server and content to prohibit screening out commericals or bookmarking post-gateway URLs.

The user is forwarded to requested content 952 after the ad is finished. The X changes to standard minimize & close buttons in System Software player, and alt-tab no longer terminates stream. If the user executes alt-tab or minimize during the commercial, a new warning may appear with an audio announcement reminding the user of the consequences of ad evasion.

What I claim as my invention is:

1) A method that leads to the effect of ceasing an advertisement and keeping user from receiving content requested when said user executes alt-tab keystroke during an advertisement.

2) A method that leads to the effect of ceasing an advertisement and keeping user from receiving content requested when said user during an advertisement clicks to minimize window.
